(19) United States
(12) Patent Application Publication
(10) Pub. No.: US 2024/0255937 A1
(43) Pub. Date: Aug. 1, 2024

(54) METHOD FOR DIAGNOSING A CONTROL-AND/OR REGULATING SYSTEM OF A PROCESS FACILITY COMPRISING AT LEAST ONE ACTUATOR FOR ADJUSTING A PROCESS FLUID AND CONTROL-AND/OR REGULATION SYSTEM

(71) Applicant: Samson Aktiengesellschaft, Frankfurt am Main (DE)

(72) Inventors: Andreas Fiebiger, Taunusstein (DE); Christian Fiebiger, Hofheim Am Taunus (DE); Tobias Boll, Frankfurt Am Main (DE)

(73) Assignee: Samson Aktiengesellschaft, Frankfurt am Main (DE)

(21) Appl. No.: 18/566,167

(22) PCT Filed: May 16, 2022
(86) PCT No.: PCT/EP2022/063119

§ 371 Date: Dec. 1, 2023

(30) Foreign Application Priority Data
Jun. 2, 2021 (DE) 102021114324.1

(51) Int. Cl. G05B 23/02

(52) U.S. Cl. CPC G05B 23/0275; G05B 23/0224

(57) ABSTRACT

A method for diagnosing a control/regulating system of a process facility having an actuator for setting a process fluid, may include: providing a diagnostic database with assignment of multiple state causes to a respective set of specified system reference properties, where each system reference property is assigned a necessary condition; providing a test database with an assignment of different diagnostic tests for a specified system reference property; detecting an actual system property of the system; determining a first system reference property, the condition of which is satisfied by the actual system property; for at least one state cause with a set of specified system reference properties, for a second system reference property of the set, detecting whether the condition assigned to the second system reference is certain; and ascertaining a diagnostic test the second system reference property.

### CROSS REFERENCE TO RELATED APPLICATIONS

This patent application is a U.S. national stage application of International Application No. PCT/EP2022/063119, filed May 16, 2022, which claims priority to German Patent Application No. 10 2021 114 324.1, filed Jun. 2, 2021, each of which is incorporated herein by reference in its entirety.

### BACKGROUND

### Field

The disclosure relates to a method for diagnosing a control- and/or regulation system of a process plant with at least one actuator for adjusting the process fluid. The disclosure also relates to a data processing system, in particular a control- and/or regulation system for a process plant with at least one actuator for adjusting a process fluid flow.

### Related Art

In general, continuous operation of process plants is provided. Many processes also require precise process control. If one or more actuators in a process plant fail or malfunction, this can result in considerable economic losses. In some processes, the risk of a fault or defect in an actuator can even pose a danger to system components, the environment and people. Many actuators and process plants are therefore equipped with fault detection- and, if necessary, diagnostic capacities in order to detect fault conditions as quickly as possible on the basis of existing fault symptoms. Some actuators and process plants are also equipped with analysis capacities in order to predictively detect states during per se fault-free operation that indicate the probable imminent occurrence of a fault. Warning symptoms that indicate increasing wear, fatigue and/or ageing can be detected and analyzed as an indicator of the expected imminent occurrence of a wear, fatigue and/or ageing-related fault. For example, an actuator can be arranged to compare empirical values and real ageing conditions with regard to the actuator in order to draw conclusions about the expected remaining service life of the actuator based on experience. In many cases, several different potential causes of faults can be considered for the occurrence of warning- and fault symptoms, so that the operator of the process plant is often unable to clearly assign a warning or fault symptom to a specific cause of the fault and therefore cannot easily deal with the cause of the fault.

DE 102 52 892 A1 describes a method for diagnosing field devices in process automation technology, in which an autonomous software agent independently and proactively monitors different data in a field device while pursuing several objectives and automatically searches for malfunctions.

EP 3 579 074 A1 discloses a fault tree-supported analysis method based on Boolean logic. The method is intended in particular for safety-critical multi-component systems. The method is intended to calculate states in which system failures can occur, as well as their causes and effects. For the method, the multi-component system is modeled considering functional dependencies between individual components. The method described is intended to eliminate logical circular reasoning. The method is not capable of clearly determining the cause of a fault.

From DE 10 2019 108 268 A1 a system for detecting and localizing faults in a pneumatic system is known. The system has a detection algorithm for calculating an anomaly score on the basis of a set of read-in signals. If a calculated anomaly score indicates an anomaly, the system is arranged to perform a machine localization procedure to localize the fault. The machine localization procedure may have previously been trained in a training phase in order to calculate on the basis of a circuit diagram for the automation system for the calculated anomaly score probabilities for possible causes of faults in relation to individual components of the automation system and to provide the result. This described system is also not capable of clearly determining the cause of a fault. A particular disadvantage of such methods is that the imprecise identification of one or more supposed sources of fault often leads to an uneconomical maintenance effort if actually fault-free components are subjected to unnecessary maintenance work or, if necessary, replaced and the process may even be interrupted for this purpose.

EP 2 987 040 B1 relates to a method for diagnosing combinations of faults in a system. The diagnosis concerns a combination of system faults. It comprises receiving symptom data relating to detected or monitored symptoms in the system. With the help of a so-called “L-best interference (Ranked Algorithm (RA))” technique it is, based on the symptoms, calculated which combination of faults is the most likely cause of the symptoms. A clear statement cannot be made with this method. It has been shown that in many cases, addressing a combination of faults that has been identified as the most probable according to the method described could not identify the actual relevant cause of the fault, resulting in unnecessary and therefore uneconomical maintenance work.

EP 3 335 089 A1 deals with a method for determining diagnostic patterns for time series of a technical system. Starting from a diagnostic pattern, possible extensions of this pattern are determined. Then a set of sequences from detected time series is determined in which an extended pattern is recognized. For each of these sequences, it is checked whether it can be associated with the occurrence of fault events. The extended pattern that is assigned to the most fault events is then considered as a new diagnostic pattern. In this way, a diagnostic system should be able to learn which time series patterns indicate the occurrence of certain characteristics. However, the method cannot be used in particular to diagnose fault- and warning symptoms that are not clearly assigned to a diagnostic pattern.

### BRIEF DESCRIPTION OF THE DRAWINGS/FIGURES

The accompanying drawings, which are incorporated herein and form a part of the specification, illustrate the embodiments of the present disclosure and, together with the description, further serve to explain the principles of the embodiments and to enable a person skilled in the pertinent art to make and use the embodiments.

FIG. 1 a schematic representation of a method for diagnosing a control- and/or regulation system according to an exemplary embodiment.

FIG. 2 a schematic representation of a method for diagnosing a control- and/or regulation system according to an exemplary embodiment.

FIG. 3 a schematic representation of a method for diagnosing a control- and/or regulation system according to an exemplary embodiment.

FIG. 4 a schematic representation of a diagnostic database according to an exemplary embodiment.

FIG. 5 a schematic representation of the detection of the presence or absence of a particular state cause according to an exemplary embodiment.

FIG. 6 a schematic representation of the determination of diagnostic tests corresponding to various system-reference-properties according to an exemplary embodiment.

FIG. 7 a schematic representation of a process plant according to an exemplary embodiment.

The exemplary embodiments of the present disclosure will be described with reference to the accompanying drawings. Elements, features and components that are identical, functionally identical and have the same effect are—insofar as is not stated otherwise—respectively provided with the same reference character.

### DETAILED DESCRIPTION

In the following description, numerous specific details are set forth in order to provide a thorough understanding of the embodiments of the present disclosure. However, it will be apparent to those skilled in the art that the embodiments, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring embodiments of the disclosure. The connections shown in the figures between functional units or other elements can also be implemented as indirect connections, wherein a connection can be wireless or wired. Functional units can be implemented as hardware, software or a combination of hardware and software.

An object of the disclosure is to overcome the problems of the prior art, in particular to provide a diagnosing method and/or data processing system, in particular a control- and/or regulation system, for a process plant, which can ensure a clear diagnostic statement regarding a cause of a fault even if, on the basis of a warning- and/or fault symptom, no direct conclusion can be drawn as to the cause of the fault provided. Accordingly, a method for diagnosing a control- and/or regulation system of a process plant with at least one actuator for adjusting a process fluid is provided. A process plant may be, for example, a chemical plant, such as a petrochemical plant, a power plant, such as a nuclear power plant, a food processing plant, such as a brewery, or the like. An actuator may generally be an apparatus, which may be controlled or regulated, for influencing a process fluid in the process plant, such as a pump, an on/off valve, a control valve or the like. The control- and/or regulation system comprises at least one actuator. Alternatively, the control- and/or regulation system may comprise a plurality of actuators of the same and/or different types. In particular, the control- and/or regulation system may comprise at least one group of actuators of a process plant, for example a group of similar actuators, a group of actuators which is assigned to a specific functional and/or local sub-area of the process plant, or all actuators of the process plant, in particular those interacting with the process fluid. In an exemplary embodiment, the group of actuators comprises or consists of actuators which are operated with an auxiliary energy fluid, for example a hydraulic fluid or a pneumatic fluid, and/or electrically. A pneumatically operated actuator comprises a pneumatically actuated actuator, such as a pneumatic cylinder with spring return, or two pneumatic cylinders that can be pressurized in opposite directions.

The method according to the disclosure comprises as step (a) the provision of a diagnostic database comprising an assignment of a plurality of state causes to a respective set comprising a plurality of predetermined system-reference-properties. Thereby, each system-reference-property is assigned at least one necessary condition.

A necessary condition may, for example, relate to a minimum threshold value, a maximum threshold value, a bandwidth in relation to a system-actual-property, such as at least one measured value, or the like. A necessary condition may additionally or alternatively refer to the presence or absence of a predetermined signal, for example, an end-stop-button-signal, an emergency-stop-switch-signal, a dead-man's-switch-signal or the like. A system-reference-property can be assigned to a necessary condition, wherein in the presence of system-actual-properties that realize a (single) necessary condition, the assigned system-reference-property is fulfilled. If a necessary condition is not realized by the system-actual-property, the condition(s) of this system-reference-property is/are not fulfilled. If no currently valid measured value or no currently valid signal is available for a system-actual-property, the necessary condition correlating to this system-actual-property is undetermined.

A set of system-reference-properties consists of at least one system-reference-property or comprises two or more system-reference-properties. A system-reference-property can be, for example, a measured value or a state value, such as a diagnostic result, for example a warning message or a fault message. In the method according to the disclosure, a diagnostic database is provided which comprises an assignment of a plurality of state causes to a respective set comprising a plurality of predetermined system-reference-properties, wherein the diagnostic database may further comprise an assignment of one or more state causes to a respective set consisting of only one system-reference-property. A system-reference-property can also be a specific group of different, in particular mutually correlating, measured values and/or a sequence of several, in particular similar or different, measured values according to a predetermined temporal sequence. In particular, the diagnostic database can be provided in such a way that several different state causes, in particular fault causes, are assigned to a respective set of predetermined system-reference-properties according to a causal correlation, which can be designated as warning- and/or fault symptoms. A diagnostic database may be provided in which a unique causal correlation of detectable effect in the form of a set of predetermined system-reference-properties to the assigned fault cause in the form of a state cause is stored, in particular for at least ten, at least 50, at least 100 or more state causes. The diagnostic database is designed in such a way that an unambiguous assignment of a predetermined state cause to a specific set of predetermined system-reference-properties is provided, so that the presence of the assigned state cause can be unambiguously inferred from knowledge of the system-reference-properties. The diagnostic database may be provided using a computer-readable storage medium. Implicitly or explicitly, the diagnostic database can reflect which system-reference-property(-ies) and which state causes are not causally correlated.

As step (b), the method according to the disclosure comprises providing a test database comprising an assignment of at least different diagnostic tests to at least one predetermined system-reference-properties each. The test database may be provided using a computer-readable storage medium. A database, for example a diagnostic database or a test database within the meaning of the present disclosure generally refers to a data structure which reflects a reproducible, in particular bidirectional, correlation of at least one first type of data (for example state causes or diagnostic tests) to at least one second type of data (for example system-reference-property) on at least one computer-readable storage medium. The test database may include an assignment of one or more diagnostic tests to a plurality of predetermined system-reference-properties. A diagnostic test generally refers to a test routine or a test procedure with which, possibly by performing a specific influence on a single actuator or several actuators, information for determining at least one system-reference-property is obtained. For an actuator in the form of a pneumatically actuated control valve, for example, the so-called partial stroke test (or partial-stroke-test), which is a test method in which a control valve, in particular one that is linearly movable, is moved in a targeted manner in a delimited control range in order to, based on a predetermined electrical or pneumatic control signal as a system-actual-property, detect the actuating response of the pneumatic control valve (e.g. actuating speed, actuating position as a function of the actuating pressure) and thus to detect one or more system-reference-properties, such as warning symptoms or fault symptoms (e.g. behavior OK, changed friction, altered friction, altered actuating distance, wrong direction of actuating distance). In other words, the test database reflects which diagnostic test or tests are suitable for determining a predetermined system-reference-property. In addition, the test database can reflect which predetermined system-reference-property(ies) can be determined using one or more predetermined diagnostic tests. Implicitly or explicitly, the test database can reflect which predetermined system-reference-properties any diagnostic tests are not capable of recognizing.

Steps (a) and (b) can be carried out in any order, in particular before steps (c), (f) and (g) and possibly before step (d) and/or (c). It is conceivable that steps (a) and (b) are carried out simultaneously. It is conceivable that step (a) and/or (b) is initially carried out at the beginning of the method according to the disclosure. In addition, or alternatively, step (a) and/or (b) can be performed again at least partially, for example in order to adapt the diagnostic database and/or the test database with regard to a change in the architecture, in particular with regard to a change in the actuator(s) of the control- and/or regulation system. Alternatively, or additionally, step (a) (b) can be at least partially re-performed in order to adapt a diagnostic database with regard to knowledge gained in the meantime about causalities between state causes, such as fault causes, and system-reference-properties, such as warning- or fault symptoms. Step (b) can also be carried out again, at least in part, in order to adapt further diagnostic tests, in particular with regard to their assigned system-reference-properties.

In the method according to the disclosure, at least one system-actual-property of the control- and/or regulation system is detected according to a step (c). The system-actual-property can, for example, be detected as part of a diagnostic test and/or during the operational use of the at least one actuator or the control- and/or regulation system. The detection of a system-actual-property can, for example, involve carrying out a measurement and/or reading out a sensor value or calculating a value derived from one or more sensor values. Alternatively, or additionally, detecting a system-actual-property may comprise reading out at least one binary signal, such as an emergency-stop-switch-signal, an end-stop-button-signal or the like. The detection of a system-actual-property can, for example, include the correlation of at least one setpoint value, such as a control pressure value or an electrical actuating signal, and at least one actual value assigned to the setpoint value, such as a valve position, for example as part of a diagnostic test, such as a partial stroke test.

The method according to the disclosure further comprises a step (d), according to which at least one first system-reference-property is determined, the at least one necessary condition of which is fulfilled by the at least one system-actual-property detected in step (c). The first system-reference-property may, for example, be a first warning symptom, which may have been causally caused by several different state causes.

Furthermore, it is provided according to the disclosure that in a further step (e), on the basis of the diagnostic database for the at least one state cause whose set of predetermined system-reference-properties comprises the first system-reference-property determined in step (d), for at least one second system-reference-property of this set, it is detected, in particular based on the at least one system-actual-property(ies) detected in step (c), whether the at least one condition assigned to the second system-reference-property is determined. In an exemplary embodiment, it is provided that, in response to the detection of the at least one system-actual-property with respect to which the at least one first system-reference-property is determined in step (d), step (e) is caused to be performed. In an exemplary embodiment, step (e) may be performed several times consecutively or simultaneously with respect to several different state causes, wherein in particular the several state causes for which step (e) is performed several times consecutively or simultaneously all comprise the first system-reference-property determined according to step (d). As described above with respect to step (a), a system-reference-property may be determined to be fulfilled or not fulfilled based on the necessary condition assigned to it. For example, the necessary condition may be defined based on a minimum threshold value, wherein when the minimum threshold value is exceeded by a system-actual-property, the condition is fulfilled and wherein when the minimum threshold value is not reached, the condition is not fulfilled. For example, a minimum threshold value can be a minimum temperature. If no valid current system-actual-property was detected, for example because an assigned measurement signal was not retrieved or at least not retrieved within a predetermined time frame, or if a value derived from measurement signals was not calculated or at least not calculated within a predetermined time frame, the assigned necessary condition is undetermined. For example, a time frame can be defined by a cycle, such as a 5-minute cycle, and no temperature measurement has been taken or retrieved within the past cycle duration. If the respectively assigned condition is determined for all system-reference-values, i.e. either fulfilled or not fulfilled, the diagnostic database can be used to determine that the assigned cause of the fault is clearly present or clearly not present. However, as long as at least one necessary condition is undetermined, neither the presence nor the absence of a state cause can be ruled out due to a lack of clear information on its at least one predetermined second system-reference-properties.

According to step (f), according to the disclosure, at least one corresponding diagnostic test is determined on the basis of the diagnostic database for the at least one second system-reference-property with a necessary condition detected as undetermined in step (d). In an exemplary embodiment, it is provided that in response to the fact that at least one second system-reference-property with an undetermined assigned condition is recognized in step (c), performing of step (f) is initiated. It is conceivable that step (f) comprises a first sub-step (f1), according to which the second system-reference-property with the necessary condition detected as undetermined is first marked as an open system-reference-property on the basis of the test database. In addition, step (f) can comprise a second sub-step (f2), according to which, on the basis of the diagnostic database following the first sub-step (f1), a diagnostic test corresponding to the open system-reference-property is determined. According to the disclosure, it is provided that, based on the previously performed detection that the necessary condition of the second system-reference-property is currently undetermined, one or more diagnostic tests are identified which are suitable for causing a determination of the necessary condition as fulfilled or not fulfilled, in order to, on the basis of the second system-reference-property which can then be determined or is determined, be able to make at least a more concrete statement about the existence or non-existence of the assigned state cause. The method according to the disclosure allows performing an unambiguous determination of the state cause based on an identified system-reference-property, such as a warning symptom or fault symptom, which in itself would not normally allow an unambiguous conclusion to be drawn about the underlying state cause, for example the underlying fault state. An uncertain and imprecise guessing of possible fault causes on the basis of an automated determination of one or more probable state causes can be omitted and thus unnecessary effort and possibly unnecessary downtimes of the process plant can be avoided. With the method according to the disclosure, actual state causes can be determined and the necessary steps for their treatment can initiated in a targeted manner.

In one embodiment of the method according to the disclosure, a further step (g) is provided in which the at least one diagnostic test previously determined in step (f) is carried out in order to detect a system-actual-property corresponding to the second system-reference-property and, based thereon, to determine the assigned necessary condition, in particular to determine whether the necessary condition of the (open) second system-reference-property is fulfilled or not fulfilled by the system-actual-property. In the event that, starting from the previously described method step (c), several second system-reference-properties were detected as undetermined, i.e. were determined with a respective undetermined condition, and/or starting from the previously described method step (f), several diagnostic tests for two or more second system-reference-properties were determined, step (g) can correspondingly be carried out several times in order to carry out several diagnostic tests. The number of the several diagnostic tests for determining the second system-reference-properties may be less than the number of second system-reference-properties to be determined, for example by performing at least one diagnostic test with which the respective conditions for two or more second system-reference-properties can be determined at once. The at least one diagnostic test according to step (g) may be performed immediately after step (f) has been performed. In particular, step (g) can be repeated in the case of several undetermined second system-reference-properties with undetermined necessary conditions for performing different diagnostic tests, in particular repeated at least until a clear identification of a state cause for the present determined system-reference-properties has been implemented.

According to a further embodiment of the disclosure, the at least one diagnostic test in step (g) is only performed after an operator release, in particular a manual operator release. It may be provided that, after a single operator release, exactly one diagnostic test is performed or several diagnostic tests are performed, such as successively. Alternatively, it may be provided that each diagnostic test to be performed requires an individual operator release beforehand. Alternatively or additionally, it is conceivable that it is detected on the basis of the diagnostic database whether a diagnostic test requires an operator release or not, for example if, on the one hand, a first type of diagnostic tests can be performed during ongoing system operation without disturbing the system process, whereas, on the other hand, another type of diagnostic tests cannot be performed without expected disturbance of the system process, at least in the presence of certain operating conditions. In addition, it is conceivable that, if several diagnostic tests were determined in step (f), an operator release is to be specified, which determines a prioritization or sequence with regard to the diagnostic tests to be performed. For example, it is conceivable that an operator can release a diagnostic test to be performed between several diagnostic tests available for selection.

In one embodiment of the disclosure, a diagnostic test is determined in step (f) with respect to a state cause, of whose set of system-reference-properties at least one is present, in particular several are present, wherein in particular only a single second system-reference-property of the set is undetermined. If a plurality of state causes are to be determined on the basis of the first system-reference-property, a diagnostic test can be determined in step (f) for a second system-reference-property of a set of one of the several state causes to which fewer system-reference-properties, in particular fewer (open) second system-reference-properties, are assigned than to the respective set of the other state cause(s) to be determined. Thus, the determination of the several diagnostic tests to be performed can be carried out on the basis of the diagnostic database for the state causes assigned to the first system-reference-properties in such a way that at least one diagnostic test is determined as having priority, with which a clear identification of the presence or absence of one of the state causes can be made as directly and/or quickly as possible.

According to a further embodiment of a diagnosing method according to the disclosure, which can be combined with the previous ones, a diagnostic test is determined in step (f) which corresponds to at least one second system-reference-property which is assigned to at least two different state causes. In particular, on the basis of the diagnostic database with regard to a several second system-reference-properties with a respective undetermined necessary condition, a determination of the diagnostic tests to be performed can occur in such a way that the number of diagnostic tests is minimized, i.e. that with the smallest possible number of diagnostic tests as many necessary conditions as possible relating to different system-reference-properties are determined.

According to a further development of a diagnosing method in which at least one diagnostic test is performed in step (g), in a further step (h) following step (g) and on the basis of the system-reference-property determined in this step (g) and the diagnostic database, a corresponding state cause is detected, in particular as being unambiguously present. In step (h), at least one first system-reference-property and at least one second system-reference-property of a set of system-reference-properties determined in step (g) can be considered.

According to a further development of the diagnosing method, on the basis of the state cause detected in step (h), a state message relating to this state cause, such as a recommended action, warning message or fault message, can be provided. In this way, based on the diagnosing method according to the disclosure rapid and targeted treatment of an unambiguously identified state cause may occur.

In one embodiment of the diagnosing method according to the disclosure, at least one system-actual-property can be detected in step (c) during ongoing control- or regulation operation of the control- and/or regulation system. Alternatively, or additionally, in step (c), at least one system-actual-property can be detected in a test operation of the control- and/or regulation system (during a diagnostic test), in particular by performing a diagnostic test on a scheduled and/or regular basis. For example, a diagnostic test can be performed regularly at predetermined intervals or at predetermined times. Alternatively, a diagnostic test can be carried out as scheduled under certain boundary conditions, which can be identifiable on the basis of one or more system-actual-properties.

According to another embodiment of a diagnosing method according to the disclosure, in step (d) at least one system-reference-property can be determined on the basis of a necessary condition defined as a history set of rules, wherein an assignment of a predetermined temporal sequence and/or duration of system-reference-properties, such as measured values, binary status signals or the like, to the first system-reference-property is performed on the basis of the history set of rules.

The disclosure further relates to a system for data processing, comprising means for performing the method described above, in particular according to one of the embodiments or further embodiments of the disclosure described above.

The disclosure also relates to a system comprising a control- and/or regulation system for a process plant with at least one actuator for adjusting a process fluid flow. In particular, the control- and/or regulation system is configured to carry out the method according to one of the embodiments or further embodiments of the disclosure described above. To perform the diagnosing method, the system, for example the control- and/or regulation system, may comprise at least one computer-readable memory for the diagnostic database and the test database, and may comprise at least one computer configured to perform at least part of the method steps (c), (d), (e) and/or (f) and, if necessary, (g) and/or (h). The system, in particular control- and/or regulation system, may comprise a plurality of computer-readable memories and computers which are interconnected in a data transmission manner. Additionally, or alternatively, the system, in particular control- and/or regulation system, may comprise at least one sensor, in particular a plurality of sensors. For example, the control- and/or regulation system may comprise or consist of at least one control and/or regulation electronics of an actuator. The control- and/or regulation system may comprise several control- and/or regulation electronic units of several actuators. Additionally, or alternatively, the control- and/or regulation system may comprise a control room of a process plant. The system, in particular the control- and/or regulation system, can be connected to at least one cloud storage and/or cloud computer for data transmission. It is conceivable that system-actual-properties of the control- and/or regulation system are detected locally on the actuator(s) of the process plant. The provision of the diagnostic database and/or the test database can be implemented either locally in the region of the process plant or spatially separated from the process plant. The at least one processor or computer for carrying out at least one of steps (d), (e) and/or (f) and, if applicable, (g) and/or (h) can be arranged locally in the region of the process plant, for example in or near an actuator or a control room, or can be implemented spatially separated from the process plant.

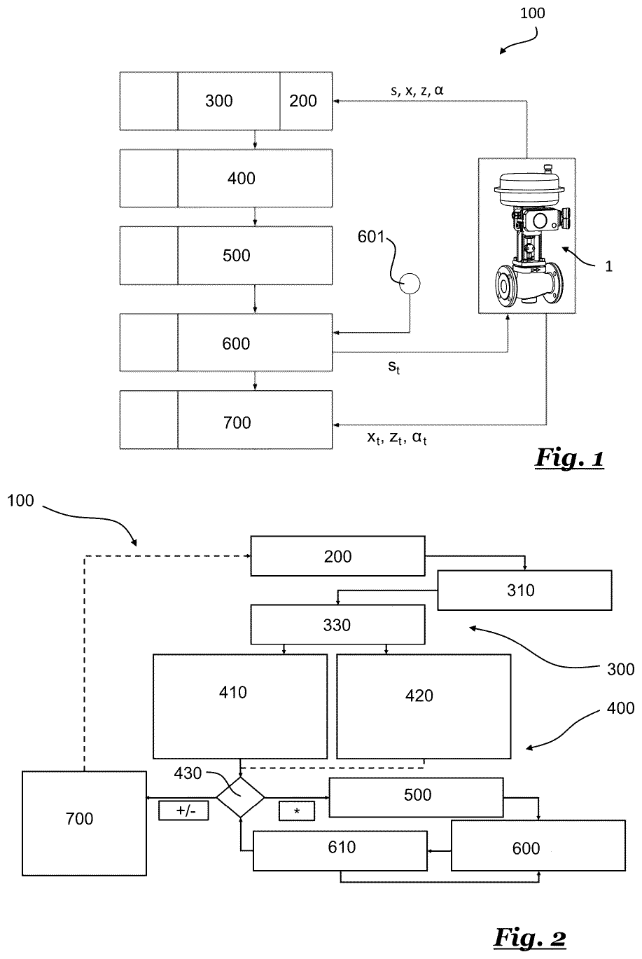

FIG. 1 shows a simplified representation of a method according to the disclosure for diagnosing a control- and/or regulation system of a process plant with at least one actuator. An actuator 1 is shown here by way of example as a pneumatically actuated control valve with an electropneumatic actuator. The illustrated actuator is exemplary for any type and number of actuators of a process plant 10.

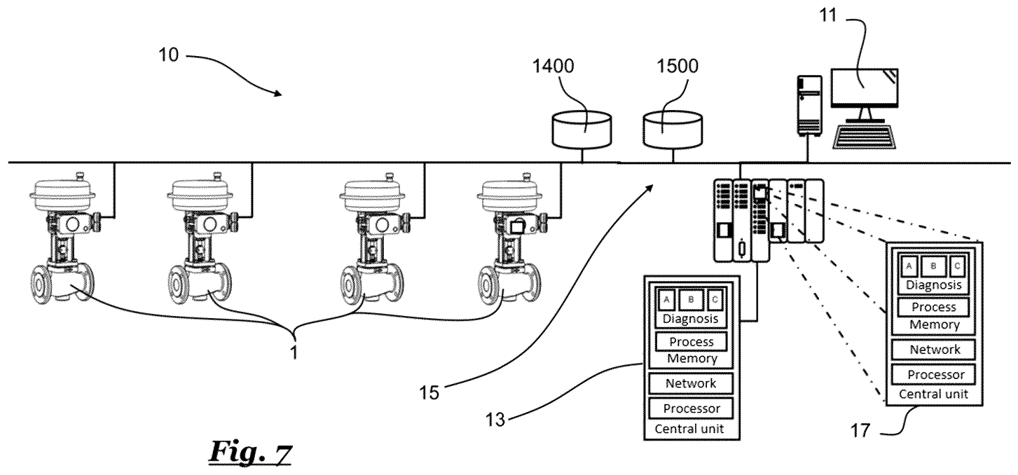

FIG. 7 schematically forms a process plant 10. It should be clear that the steps of a diagnosing method according to the disclosure described below are performed at least partially during the ongoing operation, in particular during the ongoing control- and/or regulation operation, of a process plant 10, such as without impairing, disturbing or interrupting the ongoing operation of the process plant 10.

The process plant can, for example, have a control room 17 which is arranged and adapted for the central control and/or regulation of the processes of the plant 10. Methods for controlling and/or regulating the process plant and their components, in particular actuators, are known to the person skilled in the art. In order to simplify the readability and better comprehensibility of the diagnosing method according to the disclosure, explanations of the normal control and/or regulation operation are generally omitted below.

Alternatively, or additionally, the process plant can be operated in test operation to perform the diagnostic procedure. During operation of the process plant in test operation, the normal control and/or regulation mode can be completely paused or restricted. Alternatively, it is conceivable that test operation takes place during normal control and/or regulation operation, but with the proviso that normal operation is not impaired by the test operation, or that only a tolerable impairment of normal operation takes place, and/or that test operation is terminated immediately under predetermined termination conditions.

FIG. 1 shows a simplified schematic sequence of a diagnosing method 100 according to the disclosure. According to an alternative embodiment not shown in detail, it is conceivable that the diagnosing method 100 according to the disclosure is initiated by an activation command, which can be carried out, for example, by manual input at a user interface 11 of the process plant 10 or a remote maintenance device for the process plant 10.

According to the embodiment illustrated in FIG. 1, the method is initiated in response to the detection 200 of a system-actual-property. The detection 200 can, for example, take place during normal operation of the process plant. A system-actual-property denotes, for example, a digital or analog measured value, a binary status signal or another discrete status signal, for example: Motor switch ON, OFF, REP. In relation to the actuator 1, which is described here by way of example as a pneumatically actuated control valve 1, a system-actual-property can comprise a control signal s, such as an electrical (digital or analog) set-point position signal, and/or a measured value x, such as an actual position, an actual pressure or the like, a status signal z, such as an end-stop-button signal, an emergency-stop-signal or the like. Alternatively, or additionally, a system-actual-property can comprise at least a derived property, i.e. generally a property related to the actuator, which is calculated on the basis of available measured values, actuating signals and/or status signals. A derived property a can, for example, be a diagnostic value calculated by the actuator electronics of the actuator 1, such as an actuator rod friction or the like. In particular, a (derived) system-actual-property a can comprise at least one fault message and/or warning message relating to the actuator 1.

The detection 200 can be carried out by a processor or computer 13, referred to below as diagnostic electronics, which is not part of the actuator 1 but is connected to it for signal transmission, for example via a local network 15. Alternatively, it is conceivable that an actuator 1 of a process plant carries out the detection 200 in relation to other actuators 1 and/or itself (not shown in detail), i.e. the actuator 1 itself implements the diagnostic electronics. According to a further alternative, the diagnostic electronics can be realized in functional union with a control room 17.

When detecting 200 a system-actual-property, the system-actual-property may be detected 200 with an associated point in time, for example in the form of a time stamp, for example in order to be able to correlate different system-actual-properties s, x, z, a of the control- and/or regulation system from different sources, for example different actuators 1, with each other in terms of time.

Then, in a later step 300, it is provided that it is determined whether the system-actual-property(ies) s, x, z, α detected in the previous step 200 fulfill(s) the necessary condition Bᵢ of a predetermined system-reference-property m. It is conceivable that from one or more, in particular derived, system-actual-property(ies) s, x, z, α it directly or implicitly results, whether a necessary condition B of a first system-reference-property m is fulfilled. The implementation of step 300 is described in detail below with reference to FIG. 5. The first system-reference-property m determined in the step 300 may be referred to as a first symptom. For example, a system-reference-property may be a warning symptom or a fault symptom. For example, the system-reference-property may be related to the entire process plant, a functional or spatial section of the process plant, a single actuator or a plurality of actuators.

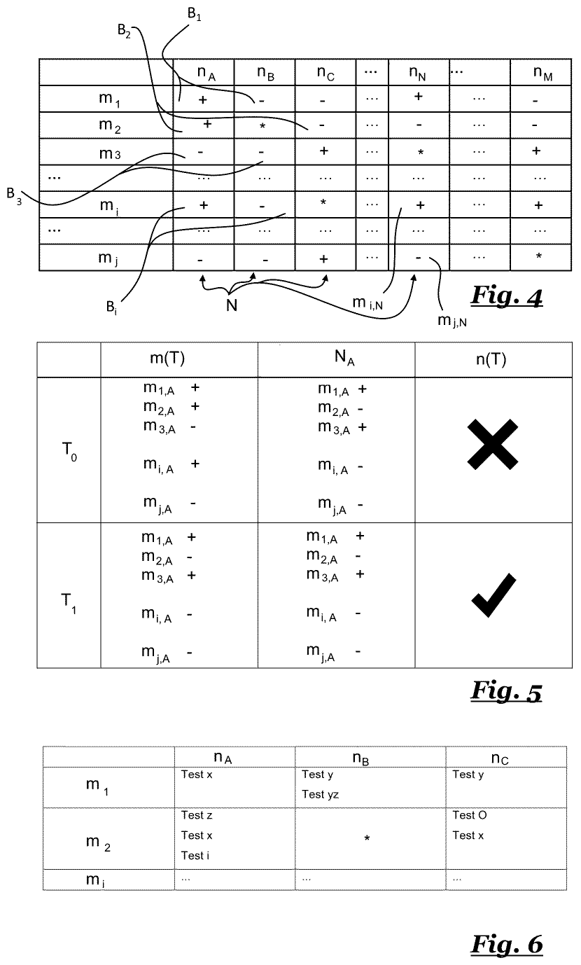

Based on the first symptom m determined in the previous step 300, a subsequent step 400 determines which possible state causes n could have caused the first symptom m. For this purpose, the computer 13 can access a diagnostic database 1400 (can also be in the actuator). The provision and use of the diagnostic database 1400 is explained in more detail below with reference to FIG. 4.

FIG. 4 schematically forms the content of a diagnostic database 1400. The diagnostic database 1400 contains a correlation between, on the one hand, several different symptoms m and, on the other hand, numerous different state causes n. In the diagnostic database 1400, each state cause n is assigned a set N comprising several different symptoms m. The matrix shown in FIG. 4 makes a statement as to which symptom-set N is caused by which state cause n.

A symptom m_{i,N} in a set N can be positively assigned to a state cause n_{N} in such a way that there is a causal relationship between this predetermined state cause n_{N} and the presence of the predetermined symptom m_{i,N}. The predetermined state cause n_{N} results in the predetermined positive symptom min assigned to it. Alternatively, or additionally, another symptom m_{j,N} in a set N can be negatively assigned to the state cause n_{N} in such a way that there is a causal relationship between this predetermined state cause and the absence of the predetermined negative symptom m_{j,N}. The predetermined state cause n has the consequence that a predetermined negative symptom m_{j,N} assigned to it does not occur. If all positive symptoms m of the set N of a predetermined state cause n are present and all negative symptoms m of this set N are not present, the presence of the state cause n assigned to set N can be clearly inferred from this.

Optionally, it can be defined with regard to a state cause if a symptom is not causally related to this state cause, or in other words, if the state cause is irrelevant for the system-reference-property. In FIG. 4, positive correlations between a state cause and a symptom are indicated with a “+” and negative correlations with a “−”. If there is a correlation between a symptom and a state cause, this symptom is necessary for detecting the state causes. The * symbol marks non-meaningful state cause/symptom relationships. If the state causes/symptom relationship is not meaningful, this symptom is not necessary with regard to the respective state cause. It is conceivable that a further “optional” category (not shown here in more detail) may be noted in the diagnostic database 1400 with regard to the relationships between a symptom and a state cause if the optional symptom is not absolutely necessary for detecting a state cause, but can improve the informative value of the diagnosis on the basis of the diagnostic database 1400.

FIG. 5 schematically reflects a time-dependent detection of the existence or non-existence of a state cause n_{A} as a function of the set N_{A} of predetermined system-reference-properties m_{1,A}, to m_{n,A} assigned to this cause. At the points in time T₀ and T₁, all system-reference-properties relevant to the cause n_{A} are determined.

For example, the first symptom m_{1,A} relevant with regard to the state cause n_{A} is determined to be present at both points in time T₀ and T₁. At both points in time T₀ and T₁, the diagnostic electronics can therefore detect or determine that the condition B₁ assigned to the first system-reference-property m_{1,A} is fulfilled. In contrast, the second symptom m_{2,A} relevant with regard to the state cause n_{A} is determined at both points in time, determined as present at time T₀ and determined as not present at time T₁. The third symptom m_{3,A} relevant to the state cause n_{A} is determined at both points in time, determined as not present at time T₀ and determined as present at time T₁. The diagnostic electronics therefore determine the non-existence of the state cause n_{A} at time T₀. At the time T₁, all system-reference-properties m_{1,A} to m_{1,n} assigned to the state cause n_{A} correspond to the set N_{A}. Thus, the existence of the state cause n_{A} is determined by the diagnostic electronics at the time T₁.

Returning to FIG. 1, starting from the first symptom m after determining the possible state causes n assigned to it in step 400, it can then be detected whether all symptoms or system-reference-properties of the various sets N of the respective state causes n are determined or undetermined.

Sufficient current information is available for a particular symptom to allow a clear determination of whether this symptom is present or absent. If all symptoms of a set N are determined, the positive and/or negative correlations between the symptoms of the set and the state causes assigned to the set can then be used to draw a clear conclusion about the existence or non-existence of this state cause.

For an undetermined symptom, which may also be referred to as an open symptom or second (open) system-reference-property, diagnostic electronics performing the diagnosing method 100 do not have sufficient current information. For example, the diagnostic electronics may not have any information regarding the second system-reference-property. Alternatively, the diagnostic electronics may have outdated, no longer current, information regarding the second system-reference-property. If a set N contains an undetermined symptom or several undetermined symptoms, the diagnostic electronics cannot conclude whether the state cause n assigned to the set exists or does not exist.

In the diagnosing method according to the disclosure, following step 400, step 500 is carried out, according to which all suitable diagnostic tests are listed with respect to the undetermined symptoms or open, second system-reference-properties. For a second system-reference-property mₓ, a test database 1500 can be used to determine at least one diagnostic test t that is suitable for determining the second system-reference-property. In this regard, reference is made to the following embodiments of FIG. 6.

FIG. 6 shows a tabular representation in which the diagnostic tests t assigned to the various symptoms m are shown. As shown in FIG. 6, optionally linked to the assignment of symptom m and diagnostic test t, an assignment to one or more state causes n assigned to the respective symptom m can also be provided. Based on the test database 1500, the diagnostic electronics can determine one or more suitable diagnostic tests t in order to perform a determination of open system-reference-properties mx.

Referring again to FIG. 1, following the determination 500 of at least one suitable diagnostic test t by the diagnostic electronics, it can be caused that, in a subsequent step 600, this diagnostic test t is performed or these diagnostic tests t are performed. The execution of the diagnostic tests t in step 600 can be made dependent on a triggering event 601. A triggering event 601 can be, for example, release of one or more tests t by control room 17 when a suitable system state is present or a manual user release at interface 11. In addition, or alternatively, the triggering event 601 may be a scheduled execution of a predetermined diagnostic test t, for example on a regular basis, at random intervals or in the presence of predetermined states of the process plant.

If several diagnostic tests t have been determined in step 500, the several diagnostic tests t may be performed successively one after the other. For this purpose, the diagnostic electronics can cause corresponding diagnostic test control signals sₜ to be provided in order to perform a desired diagnostic test t with respect to one actuator 1 or more actuators. The system-actual-properties occurring in response to the diagnostic test t, for example in the form of measured values xₜ or status signals zₜ, which occur as a result of performing 600 the diagnostic tests t, are in turn detected. On the basis of the detected system-actual-properties, as described above, a determination of this second system-reference-property mₓ can now occur using the respective conditions B of the second system-reference-property mₓ assigned to the diagnostic test t performed. After all previously open second system-reference-properties mₓ have been determined after performing 600 the required diagnostic tests t, the associated set N can then be used in a subsequent diagnostic step 700 to recognize whether a suspected state cause n exists or not.

In step 500, the diagnostic tests t to be performed may be prioritized, for example, with the proviso that such diagnostic tests t are performed with priority that are assigned to a particularly large number of open second system-reference-properties based on the test database 1500. Alternatively, priority may be given to diagnostic tests t which, considering the diagnostic database 1400 and the test database 1500, allow a statement to be made about the existence or non-existence of at least one state cause with the least possible test effort, for example the lowest possible number of tests, the shortest possible test duration and/or the least possible complex test conditions.

For example, the first symptom m “large permanent control deviation in the piston stroke control” can be determined in step 300. This symptom may indicate that either the state cause n_{E} “no supply air pressure” or n_{F} “blockage of the piston stroke (e.g. contamination in the piston spool)” exists. These two state causes n_{E}, n_{F} are assigned the second system-reference-property mₓ “current measured value at the supply air pressure sensor <0.1 bar” in the diagnostic database 1400, positive on the one hand and negative on the other. Based on the test database 1500, the second system-reference-property is assigned a diagnosing method that detects whether the condition “supply air pressure <0.1 bar” is fulfilled or not fulfilled based on the system-actual-property in the form of a pressure measured value related to the supply air pressure. If it is detected in step 400 that this condition is currently not determined, the relevant diagnostic tests can be determined in step 500 on the basis of the test database 1500. The diagnostic tests can be performed in the subsequent step 600. The measured value related to the supply air pressure can be detected and analyzed with respect to the condition in order to determine the symptom mx. If the supply air pressure-related measured value represents a supply air pressure of less than 0.1 bar, the symptom mₓ is fulfilled, otherwise it is not fulfilled. If the symptom mₓ is present, the diagnostic electronics will then detect in step 700 that the state cause n_{E} is present, otherwise that the state cause n_{F} is present.

FIG. 2 shows a more detailed schematic representation of an embodiment of a diagnosing method 100 than FIG. 1. The diagnosing method shown in FIG. 2 substantially differs from that shown in FIG. 1 only in that steps 300 and 400 are subdivided into substeps. Step 300 comprises the sub-steps 310 and 330. Step 400 comprises the sub-steps 410 and 430 and, if necessary, 420. For the rest, reference is made to the description with respect to FIG. 1.

At first, FIG. 2 illustrates the detection of at least one system-actual-property in step 200. Based on the detected system-actual-property, the detected system-actual-property is then first assigned to at least one corresponding system-reference-property m in step 310. This can occur, for example, by executing a diagnostic logic or analysis logic of the process plant 10 or one of its actuators 1 using one or more system-actual-properties, such as a measured value x, a status signal z, an actuating signal s and/or a derived system-actual-property a. In the assignment 310, it is checked whether a predetermined necessary condition B of the respective system-reference-property m is present or not present.

If it has been determined for a first system-reference-property m in sub-step 310 that its condition is fulfilled, a check is then carried out in sub-step 330 using the diagnostic database 1400, which possible state cause or causes n can be assigned to this system-reference-property m.

If an individual system-reference-property is clearly assigned to a single state cause, it is not necessary to carry out the diagnosing method 100 according to the disclosure. For such trivial cases with clear causal assignment of a specific state cause to a single specific system-reference-property are generally known to the person skilled in the art, and diagnosing methods not according to the disclosure are sufficient.

In the context of the diagnosing method 100 according to the disclosure, particularly relevant are those assignments 330 in which, starting from the one first system-reference-property m determined in sub-step 310, a plurality of different possible state causes n come into question.

Subsequently, in sub-step 410, with regard to these possible state causes n, it is determined, using the diagnostic database 1400, which other necessary system-reference-properties mᵢ, mⱼ are to be assigned to the possible state causes n identified in sub-step 330 on the basis of a respective set N. In sub-step 410, it can be identified implicitly or explicitly in the sense of an exclusion procedure which system-reference-properties are irrelevant with respect to the state causes n identified in sub-step 330. In addition, in an optional sub-step 420, it can be determined which optional system-reference-properties are to be assigned to the possible state causes n identified in step 330 on the basis of the respective set N.

After sub-step 410 (as well as sub-step 420, if applicable) has been performed, in sub-step 430 it is determined which of the necessary system-reference-properties m of the respective sets N are determined with respect to the possible state causes n identified in sub-step 330, i.e. which of the system-reference-properties m are clearly present or not present.

If, starting from sub-step 430, all necessary symptoms m of a set N of a possible state cause n are determined, step 700 can be carried out immediately following sub-step 430 with reference to this state cause n, i.e. starting from the determined system-reference-properties m, on the basis of the diagnostic database 1400, the corresponding state cause n is detected as clearly existing or non-existing.

For the implementation of the method 100 according to the disclosure, in sub-step 430 the case is particularly relevant according to which at least one system-reference-property m of at least one set N of the state causes n previously identified as possible in step 330 (and not already excluded as not existing in a step 700) is detected as undetermined. With respect to this undetermined or open, second system-reference-property mx, step 500 is then performed starting from sub-step 430. In step 500, for at least one undetermined symptom mx, a diagnostic test t assigned in this undetermined symptom mₓ is detected on the basis of the test database 1500 by the diagnostic electronics.

In a further step 600, the diagnostic electronics may cause at least one diagnostic test t detected in step 500 to be performed. As described above, during the execution 600 of the test, the system-actual-properties are determined, which are required to determine whether the necessary condition of at least one system-reference-property is present or not present. FIG. 2 shows a sub-step 610 for this determination. During the sub-step 610, all analysis and/or diagnosing methods required to check the system-actual-properties with respect to the necessary condition of a system-reference-properties are applied. After at least one further system-reference-property mₓ has been determined on the basis of at least one additionally performed diagnostic test t, step 700 can be performed again.

It should be understood that, unless expressly stated otherwise, the steps and/or sub-steps described above may be performed in any order and/or at least partially simultaneously. It should be understood that, with respect to various system-reference-properties, the aforementioned steps and/or sub-steps may be performed at least partially simultaneously.

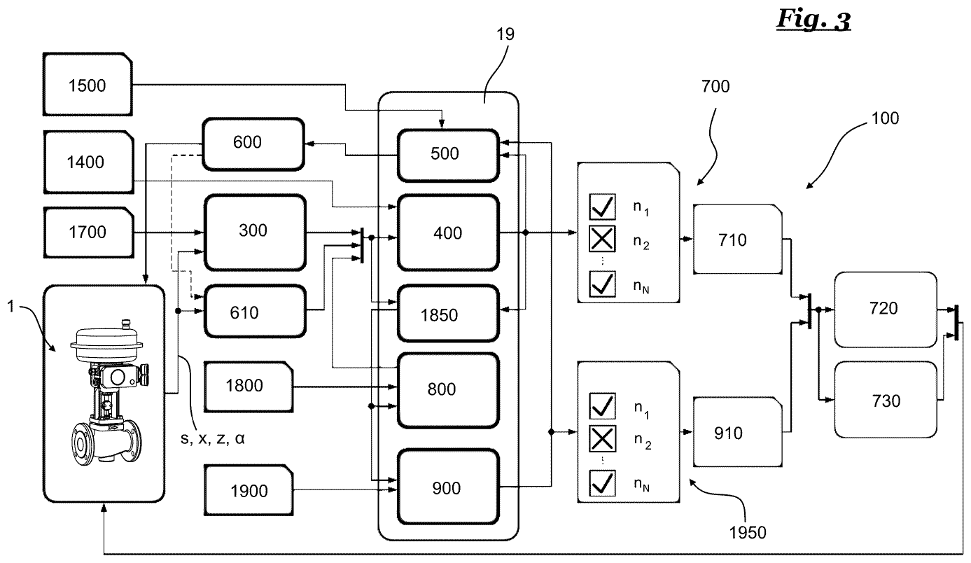

FIG. 3 shows a complex embodiment of a diagnosing method 100 according to the disclosure. The complex embodiment shown in FIG. 3 differs from the embodiments previously described with reference to FIGS. 1 and 2 substantially in that the diagnostic electronics 19 are arranged and adapted to perform an identification 800 of history symptoms and/or to perform a future-related predication 900. Alternatively, or additionally, the diagnostic electronics 19 may be arranged and adapted to determine, on the base of a unique identification of a state cause 700, an action instruction 710 for treating this state cause 700.

The system for data processing or the diagnostic electronics 19 may have at least one boundary condition database 1700 relating to at least one actuator 1, a section of the process plant 10 or the entire process plant 10, for signal-transmitting manner. The boundary condition database 1700 can, for example, be considered in the step 300 for determining a symptom.

To implement the identification 800 of history symptoms, the diagnostic electronics 19 may be equipped with at least one database 1850 comprising information on the at least partial or complete history of at least one symptom, several symptoms or all symptoms and/or state causes. It may be provided that the database 1850 of the product is continuously fed with data which is processed, for example, during the determination 300 of a first symptom and/or during the determination 400 of an open, second symptom. Alternatively, or additionally, a history-set of rules-database 1800 can be provided for implementing the history diagnostic function 800, which the diagnostic electronics 19 can access in order to identify history symptoms 800. The history-set of rules-database 1800 can, for example, map an if-then logic. The history-set of rules-database 1800 may, for example, be adapted in such way that a particular state cause and/or a particular history symptom is identified 800 under the circumstance, when a predetermined first symptom occurs first and a predetermined second symptom occurs chronologically later.

Based on the identification 800 of history symptoms, at least one system-reference-property can be determined from which the further diagnosing method 100 can be initiated. For example, starting from a temporal condition according to which several predetermined system-actual-properties and/or system-reference-properties that occur in a sequence defined in the history set of rules 1800, in particular at least partially simultaneously, can result in a predetermined system-reference-property, for example a fault symptom or a warning symptom. Based on the history set of rules 1800, the identification 800 may also consider, if a certain defined sequence of state causes occurs, possibly in combination with one or more predetermined system-actual-properties and/or system-reference-properties, and detect a corresponding system-reference-property based on such a sequence.

The future-related predication 900 may be arranged and adapted to make a prediction 1950 based on a database 1900 containing a predication set of rules and/or based on the history database 1850 with respect to events, state causes and/or system-reference-properties to be expected in the future. Based on the prediction 1950, an action instruction 910 may also be provided.

The present-related action instruction 710 and/or the future-related action instruction 910 can cause the diagnostic electronics 19 to actuate an actuator 1 or the process plant 10 in accordance with the action instruction 710 or 910 720. Alternatively, or additionally, a manual action 730 can be initiated in accordance with one of the action instructions 710 or 910, for example a replacement of a wearing part in an actuator 1, for example by issuing a corresponding request at the user interface 11.

The features disclosed in the above description, the figures and the claims can be of importance both individually and in any combination for the realization of the disclosure in the various embodiments.

1. A method for diagnosing a control- and/or regulation system of a process plant with at least one actuator for adjusting a process fluid, the method comprising:
a) providing a diagnostic database comprising an assignment of a plurality of state causes (n) to a respective set comprising a plurality of predetermined system-reference-properties (m), wherein each system-reference-property is assigned a necessary condition (B);
b) providing a test database comprising different diagnostic tests (t) each assigned to at least one predetermined system-reference-property (m);
c) detecting at least one system-actual-property (s, x, z, α) of the control- and/or regulation system;
d) determining at least one first system-reference-property (m), the condition (B) of which is fulfilled by the detected at least one system-actual-property (s, x, z, α);
e) detecting, based on the determined at least one system-actual-property (s, x, z, α) and using the diagnostic database, for at least one state cause (n), of the plurality of state causes, whose set (N) of predetermined system-reference-properties (m) comprises the determined first system-reference-property (m), and for at least one second system-reference-property (mₓ) of this set (N), whether the condition (B) assigned to the second system-reference-property (mₓ) (i) is determined or (ii) is undetermined; and
f) determining at least one diagnostic test (t), based on the test database, corresponding to the at least one second system-reference-property (mₓ) with the necessary condition (B) detected as undetermined.

2. The method according to claim 1, further comprising:
(g) performing the determined at least one diagnostic test (t) to:
detect a system-actual-property (s, x, z, α) corresponding to the second system-reference-property (mₓ); and
based thereon, determine the assigned necessary condition (B), including determining whether the necessary condition of the second system-reference-property (mₓ) is (i) fulfilled or (ii) not fulfilled by this system-actual-property (s, x, z, α).

3. The method according to claim 2, wherein the diagnostic test in step (g) is performed only in response to an operator release.

4. The method according to claim 1, wherein, in step (f), a diagnostic test (t) is determined with respect to a state cause (n), of whose set (N) of system-reference-properties (m) at least one is present, only a single second system-reference-property (mₓ) of the set (N) being undetermined.

5. The method according to, claim 1, wherein, in step (f), a diagnostic test is determined which corresponds to at least one second system-reference-property (mₓ) which is assigned to at least two different state causes.

6. The method according to claim 2, further comprising: (h) detecting a corresponding state cause (n) based on the system-reference-property (m) determined in step (g) and the diagnostic database.

7. The method according to claim 6, wherein, based on the state cause (n) detected in step (h), a state message relating to this state cause (n) is provided.

8. The method according to claim 6, wherein, based on the state cause (n) detected in step (h), an action instruction relating to this state cause (n) is provided to the control- and/or regulation system, the action instruction counteracting this state cause (n) and/or a system-reference-property (m) being assigned to this state cause (n).

9. The method according to, claim 1, wherein, in step (c), at least one system-actual-property (s, x, z, α) is detected in the ongoing control- and/or regulation operation of the control- and/or regulation system.

10. The method according to claim 1, wherein, in step (c), at least one system-actual-property (s, x, z, α) is detected in a test operation of the control- and/or regulation system by performing a diagnostic test.

11. The method according to, claim 1, wherein, in step (d), at least one first system-reference-property (m) is determined based on a necessary condition (B) defined as a history set of rules, an assignment of a predetermined temporal sequence and/or duration of system-actual-properties (s, x, z, α) to the first system-reference-property (m) being performed using the history set of rules.

12. A system for data processing, comprising:
one or more processors; and
memory storing instructions that, when executed by the one or more processors, cause the system to perform the method according to claim 1.

13. The system according to claim 12, comprising a control- and/or regulation system for a process plant with at least one actuator for adjusting a process fluid flow.
